(19) United States
(12) Patent Application Publication
(10) Pub. No.: US 2011/0192713 A1
(43) Pub. Date: Aug. 11, 2011

(54) MAGNETIC FUEL TREATMENT DEVICE

(76) Inventors: J. William Clements, Nova Scotia (CA); Frederick Carr Ramsay, Ontario (CA)

(21) Appl. No.: 12/761,469

(22) Filed: Apr. 16, 2010

(30) Foreign Application Priority Data
Feb. 11, 2010 (CA) 2692680

(51) Int. Cl. B01J 19/12; C10L 8/00

(52) U.S. Cl. 204/157.15; 422/186.01

(57) ABSTRACT

A magnetic fuel treatment system and apparatus has a body which houses a series of magnets, a fuel channel and a detachable cover. The apparatus is so structured and dimensioned as to provide a system which facilitates a good force to volume ratio and ease of sealability. The series of magnets mounted in the body in operative locations is purposed to create a combination of magnetic forces.

### BACKGROUND OF THE INVENTION

The present invention relates generally, to fuel treatment system and apparatus. More specifically, the invention relates to fuel treatment system and apparatus that utilize magnets to de-polymerize stored fuel.

It is well known that diesel fuel is unstable as by virtue of it being comprised of an organic fluid. Long term fuel storage is subject to deterioration, oxidation, microbial contamination, and re-polymerization. Stored fuel rapidly forms sediment and tank sludge, in addition to accumulated water.

However, research has demonstrated that when diesel fuel comes into contact with a magnetic force, the magnetic force causes the long chain molecules in the diesel fuel to remain in suspension and thereby inhibit a build up of sediment and tank sludge. Furthermore, a magnetic force if properly employed and utilized can de-polymerize fuel, break up fuel sludge and enable it to be reintroduced into the fuel.

There is a need in today's society for appropriately structured fuel treatment apparatus that utilize magnets to generate a magnetic field for contact with selective fuels. The prior art has attempted to address this need by teaching a number of apparatuses and assemblies that use magnets for fuel treatment.

For example, International Patent Application Publication No WO06034161A1 discloses a fuel treatment system for magnetically treating liquid that has upper and lower magnet assemblies, each having a magnet position cradle with conduit-receiving grooves cooperatively forming conduit-receiving apertures for receiving a fuel conduit.

U.S. Pat. No. 7,351,337 discloses a magnetic fuel conditioning apparatus which comprises a housing having an interior chamber that extends between an inlet and an outlet. Magnets are incorporated into the apparatus wherein adjacent magnets have their like poles facing each other causing a repelling polarity.

United States Patent Application Publication No 2006/0159562 discloses a magnetic fuel treatment apparatus comprising, a housing body, a cover, and magnet, the combination of which forms an inner fuel channel through which fuel may flow for treatment therein. This apparatus incorporates a single “donut-shaped” magnet to produce the magnetic force used in its fuel treatment apparatus.

United States Patent Application Publication No. 2003/0168393 discloses a magnetically treated water generating apparatus for treating liquid fuel that includes a screw guide comprising ceramic mold made of multiple element coexistence special ore. The magnetic field which is developed is a result of the inclusion of magnets with opposite poles.

U.S. Pat. No. 5,980,700 discloses a method of production of low pollution fuel that includes passing a synthetic fuel containing methyl alcohol or ethyl alcohol, butyl alcohol, toluene and heavy gasoline through a magnetic field that is the result of magnets with opposite poles. The apparatus has a U-shaped configuration.

U.S. Pat. No. 6,386,187 discloses a hydrocarbon or fossil fuel treatment apparatus comprising a non-magnetic elongate hollow tube, with magnets arranged inside and non-ferrous metal screen materials with different reduction potentials extending between magnet arrays. In one disclosed embodiment the apparatus is U-shaped and the magnetic components are contained in two separate housings. This apparatus is designed to be connected in-line in a fuel supply line of a combustion chamber.

The prior art does not envisage or indeed specifically teach a system or apparatus of a simple fuel treatment apparatus that incorporates all the features contemplated by the present invention some specific aspects of which are enumerated below:

1. Magnetic Force to Fuel Volume Ratio—An adequate and appropriate magnetic force to fuel volume ratio is an important factor in an effective magnetic fuel treatment apparatus. In addition, obtaining an optimal maximum magnetic force within the shortest distance between apparatus fuel inlet and apparatus fuel outlet is important due to the restricted space limitations for magnetic fuel treatment apparatus;

2. Scalability—A wide range of small to large fuel reconditioning application requirements exist which dictate the need for an increase or a decrease in “fuel flow rates”; and

3. Combination of Polarities—A series of magnets creating an attracting polarity combine with another series of magnets creating repelling and/or attracting magnetic pairing.

The present invention was conceived and developed having regard to the known prior art and with the purpose of providing improved fuel treatment systems and apparatus that utilize magnets.

### SUMMARY OF THE INVENTION

A broad object of the present invention is to provide an improved fuel treatment system and apparatus that utilizes magnets which address some of the deficiencies found in the prior art.

According to one aspect of the present invention there is provided a magnetic fuel treatment system and apparatus for stored fuel comprising a housing body having at least one doubly open fuel channel; a cover shaped and dimensioned for attachment to the housing and purposed to cover the fuel channel sufficiently to ensure operability forming at least one doubly open fuel burrow for fuel to flow through; a first series of magnets disposed on opposing sides of a first portion of the fuel channel oriented in a manner to create a magnet attracting pairing for the said first portion of the fuel channel; the first series of magnets so shaped and positioned to form a portion of the walls of the first portion of the fuel channel; and a second series of magnets disposed on opposing sides of a second portion of the fuel channel and being oriented in a manner to create a magnet repelling pairing for the second portion of the fuel channel; the second series of magnets being so shaped and arranged form a portion of the walls of the second portion of the fuel channel.

According to another aspect of the present invention there is provided a magnetic fuel treatment apparatus for stored fuel comprising a housing body having a doubly open fuel channel; a cover that is attached to the housing and covers the fuel channel forming a doubly open fuel burrow for fuel to flow through; a first series of magnets on opposing sides of a first portion of the fuel channel oriented in a manner to create a magnet attracting pairing for the first portion of the fuel channel; the first series of magnets forming a portion of the walls of the first portion of the fuel channel; and a second series of magnets on opposing sides of a second portion of the fuel channel oriented in a manner to create a magnet attracting pairing for the second portion of the fuel channel; the second series of magnets form a portion of the walls of the second portion of the fuel channel.

According to a further aspect of the present invention there is provided a magnetic fuel treatment apparatus for stored fuel comprising a housing body having a doubly open fuel channel; a cover that is attached to the housing and covers the fuel channel forming a doubly open fuel burrow for fuel to flow through; a first series of magnets on opposing sides of a first portion of the fuel channel oriented in a manner to create a magnet repelling pairing for the first portion of the fuel channel; the first series of magnets form a portion of the walls of the first portion of the fuel channel; and a second series of magnets on opposing sides of a second portion of the fuel channel oriented in a manner to create a magnet repelling pairing for the second portion of the fuel channel; and the second series of magnets form a portion of the walls of the second portion of the fuel channel.

A further aspect of the invention includes apparatus for the magnetic treatment of fuel, said apparatus comprises (a) a body housing said system, (b) a cover shaped and dimensioned for operational attachment to said body, (c) at least one fuel channel, (d) a magnetic force field housed in said body, (e) said magnetic force field comprising a plurality of magnets so disposed with respect to each other as to provide a force to fuel volume ratio effective in de-polymerizing stored fuel including fuel deteriorization, oxidation and facilitating fuel storage and sludge break up thus enabling said sludge to be introduced into the fuel system, and (f) at least one channel so structured as to enable flow effectively therethrough.

An additional aspect of this invention includes a system for the treatment and storage of fuel including the steps of (a) providing a housing for said system, (b) arranging and positioning a plurality of magnets within said housing, (c) said magnets being so structured and disposed with respect to each other as to provide a force field; (d) said force field providing a force to fuel volume ratio effective in de-polymerizing stored fuel, inhibiting fuel deterioration and oxidation and facilitating fuel storage, and (e) said magnetic force when effectively applied facilitating sludge break up thereafter enabling said sludge to be introduced into the fuel system.

Various aspects of this invention will become apparent to those skilled in the art from the following detailed description of the preferred embodiment, when read in light of the accompanying drawings.

### BRIEF DESCRIPTION OF THE DRAWINGS

FIG. 1 illustrates a top view of an embodiment of the present invention with the cover disposed thereon;

FIG. 2 illustrates a top view of an embodiment of the present invention with the cover removed therefrom;

FIG. 3 illustrates a cross-sectional side view of an embodiment of the present invention;

FIG. 4 illustrates a top view of an embodiment of the present invention wherein two components of the invention are in connected relationship;

FIG. 5 illustrates a top view of another embodiment of the present invention with the cover removed therefrom; and

FIG. 6 illustrates a top view of further embodiment of the present invention with the cover removed therefrom.

### DETAILED DESCRIPTION OF THE PREFERRED EMBODIMENT

A better understanding of the present invention and its objects and advantages will become apparent to those skilled in this art from the following detailed description, wherein there is described a preferred embodiment of the invention, by way of illustration of the best mode contemplated for carrying out the invention. As the man skilled in the art will realize, the invention may be modified in various respects, without departing from the scope and spirit of the invention. Accordingly, the description should be regarded as illustrative of the substance and essence of the invention readily capable of non-inventive modifications without departing from the inventive essence taught herein.

The present invention preferably comprises a single housing, having an inlet port, an outlet port, a single fuel channel, a gasket, and a housing cover. A series of magnets fits securely into slots in the housing. The magnets can be easily accessed by removing the housing cover. Likewise, the apparatus is lightweight and can be easily assembled, installed, and disassembled for inspection.

It is preferable that fuel flow through the fuel flow channel in either direction, left to right, or right to left, without changing or diminishing the characteristics of the fuel treatment process.

The present invention can be economically manufactured and assembled due to the simplicity of its design. Additionally, fuel flow capacity in the present invention can be increased without altering the size and shape of the magnets and without altering the fuel flow channel design. The depth of the housing may be altered for increasing fuel flow capacity.

The present invention has an adequate and appropriate magnetic flux force to fuel flow volume, which is a key factor in effective fuel treatment. This can be accomplished within a variety of restrictive and confined space limitations. The “U” shaped fuel channel offers significant fuel exposure to magnetic flux force within minimum distance between the fuel channel inlet port and the fuel channel outlet port. As the fuel travels down the fuel inlet channel it comes in contact with the apparatus magnets and, likewise, as the fuel travels up the fuel outlet channel, it comes in contact with the apparatus magnets. The U shape offers optimal overall fuel channel length without compromising confined space limitations.

The present invention is designed to accommodate a wide range of small to large fuel treatment application requirements that require an increase or a decrease in “fuel flow rates”. The present invention is designed to offer such scalability. The depth of the housing body and the diameter of the fuel channel are increased to increase the fuel flow rate. In addition, the ratio of magnetic flux force to fuel flow volume is altered by inserting additional magnets into the housing body. The magnets may be placed on top of each other to expand the magnet surface and magnetic force. In this way, the magnetic flux force/fuel flow ratio is maintained, and a variety of applications can be addressed, with a change to the depth of the apparatus only and without changing in the width of the apparatus. This may be important due to the space limitations for magnetic fuel treatment apparatus in many applications. If space is not an issue, two or more apparatuses can easily be connected for added fuel treatment requirements.

In particular embodiments of the present invention both attracting and repelling magnetic pairings are incorporated to provide a combination of magnetic flux force to optimally produce fuel depolymerisation.

Several embodiments of fuel treatment apparatus that utilize magnets are described below that are designed to be scalable.

According to an aspect of the present invention there is provided magnetic fuel treatment apparatus that are scalable and can be altered to suit a variety of applications which are governed by fuel flow rates. In particular, the present invention may be designed so as it may utilize magnets to de-polymerize stored fuel. It is preferable that the present invention comprises a U-shaped channel in one housing and that the channel has no such restrictions with regard to flow of fuel though it, as unrestricted fuel flow is critical.

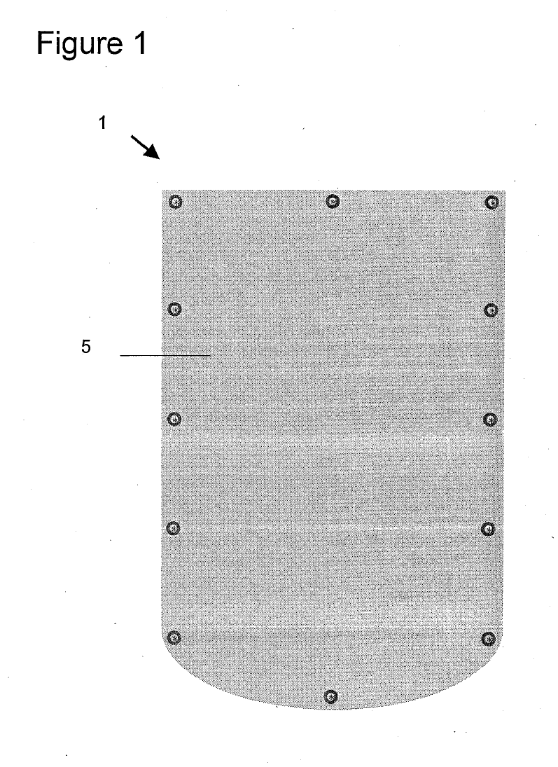

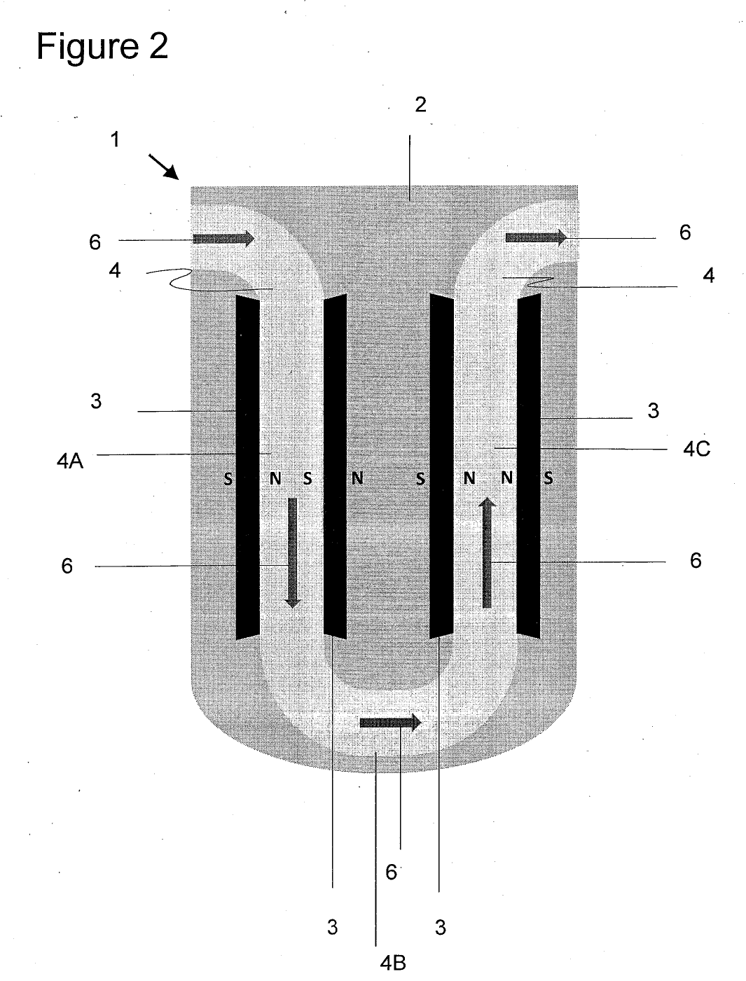

Referring to FIG. 1 (with cover 5 on) and FIG. 2 (with cover 5 off), there is illustrated in a top view, a magnetic fuel treatment apparatus 1 in accordance with an embodiment of the present invention comprising a metal housing body 2 which contains a series of magnets 3, a fuel channel 4, and a cover 5. The present invention may be fitted with seal track in the housing and a rubber seal. The cover is attached to the apparatus housing with screws or any other means. The cover rests on the top side of the fuel channel when the cover is attached to the housing thus forming a burrow. Stored fuel may flow from a storage tank and into the apparatus 1 through the fuel inlet channel 4A. As shown in FIG. 2 the fuel flow is designated by 6. The fuel inlet channel 4A originates on the upper left side of the housing body and follows a U-shaped path indicated by the arrow 6 above the curved segment of the apparatus portion 4B down the housing body, back up the right side of the housing body, and exits through an outlet channel 4C on the upper right side of the housing body.

Preferably, the housing body of the present invention is comprised of a non-magnetic material. For example, the housing body may be constructed of aluminum, bronze, or brass. It is also preferable that the fuel channel 4 have a diameter size which will accommodate a specified fuel flow in litres/gallons per minute/hour. The magnets 3 used in the present invention have a North pole and a South pole.

Slots are located along the both sides of the long sections of the fuel channel 4. The slots house a series of magnets 3 which extend along the sides of the fuel channel 4. The magnets form part of the channel walls when housed in the slots. When the cover is attached to the housing, the channel becomes a burrow for fuel flow. As fuel travels through the fuel channel 4, it comes in contact with, and is exposed to, the magnetic force as it travels over the surface of the series of magnets 3. This direct contact between the fuel and the magnets facilitates a more effective magnetic field to be delivered to the fuel. The magnetic force causes the long chain molecules in the fuel to stay in suspension and, thereby inhibits a build up of sediment and sludge. This process, known as de-polymerization, breaks up fuel sludge and enables it to be reintroduced into the fuel. Preferably, magnets 3 have their North pole on one side of the fuel inlet channel 4A and another series of magnets 3 having their South pole on the opposite side of the fuel inlet channel 4A facing the other side, creating an attracting pairing. Furthermore, it is preferable that magnets 3 having their North pole on one side of the fuel outlet channel 4C and another series of magnets 3 having their North pole on the opposite side of the fuel outlet channel 4C, be disposed creating a repelling pairing. The magnetic poles used to create a repelling pairing are not limited to North poles of the magnets 3. It is optional that there be magnets 3 having their South poles on one side of the fuel outlet channel 4C and another series of magnets 3 having their South pole on the opposite side of the fuel outlet channel 4C, creating a repelling pairing. It is also optional that the magnets 3 are oriented to create a repelling pairing for the fuel inlet channel 4A and an attracting pairing for the fuel outlet channel 4C. The combination of magnet orientations wherein magnet poles face each other either to produce an attracting or repelling pairing should not be considered limited to what is described above. For example, an attracting pairing may be produced by a north pole-south pole combination or a south pole-north pole combination. Also, a repelling pairing may be produced by a north pole-north pole combination or a south pole-south pole combination. The present invention may use any combination of poles that face each other on opposing sides of the channels to produce an attracting pairing or repelling pairing. By having different pole pairing types (i.e. attracting or repelling) on the fuel inlet channel 4A and fuel outlet channel 4C, molecular turmoil is created which may enhance the de-polymerization process.

The combination of a series of magnets 3 and the way in which the series of magnets 3 is placed in the housing body creates a strong magnetic force which affects the composition of the fuel in a positive way, and thereby causes the long chain molecules to stay in suspension and eliminates the build up of sediment and sludge. As fuel passes through the apparatus 1, the magnetic force de-polymerizes the fuel, breaks up fuel sludge and enables it to be reintroduced into the fuel. According to an aspect of the present invention the fuel successively passes through a series of magnets 3 that are oriented to create an attracting polarity for a portion of the fuel channel 4 and another series of magnets 3 that are oriented to create a repelling polarity for another portion of the fuel channel 4.

It is preferable that a U-shaped portion of the fuel channel separates the two above-mentioned portions. This “neutral zone” creates a pause in the residence time exposure between the first series of magnets before the fuel is subjected to the different magnetic field as a result of the pairing type formed by the orientation of the second series of magnets. The influence of attracting pairing followed by repelling pairing (or vice versa, repelling pairing followed by attracting pairing) creates molecular turmoil which may enhance the de-polymerization process. The series of magnets may be oriented in either of two ways; attracting/repelling or repelling/attracting, with no change to the desired effect of de-polymerization.

The apparatus 1 can operate independently or may be placed in line with water separation and fuel filtration apparatus which can extract water and dirt from the restored fuel. The size of the metal housing body 2, as well as the diameter of the fuel channel 4 and the number of magnets 3 utilized in the metal housing body 2 may be altered to accommodate increased fuel flow requirements.

In operation, stored fuel flows from a storage tank into the apparatus 1, through the fuel inlet channel 4A. As the fuel flows through the channel, it comes in contact with a series of magnets 3, which are located along the channel. The present invention may be connected to a fuel circulation pump. The circulation pump is connected to a fuel storage tank by a fuel pipe line. The fuel travels from the fuel storage tank through the fuel pipe line, through the apparatus of the, through the fuel circulation pump, and back through a fuel pipe line to the storage tank.

The present invention may also form part of an assembly of components making up a “fixed” fuel conditioning system. In one embodiment, the fuel conditioning system may include, for example (a) a circulation pump (b) apparatus for extracting water and debris from the fuel, and (c) a smart controller. In this embodiment, the fuel is pumped by the circulation pump from the fuel storage tank, through apparatus for extracting water and debris from the fuel, and through the apparatus of the present invention, back into the fuel tank. In this embodiment, the apparatus of the present invention, along with the circulation pump and apparatus for extracting water and debris from the fuel as well as the smart controller are assembled in a lockable cabinet. The cabinet is mounted to a wall or stand in close proximity with the fuel storage tank. The fuel storage tank is connected to the apparatus of the with a fuel pipe line and the fuel is pumped from the tank by the circulation pump, through the apparatus of the, and optionally, through apparatus for extracting water and debris from the fuel, and back to the fuel storage tank.

The apparatus of the present invention, the circulation pump, and optional apparatus for extracting water and debris from the fuel may be mounted on a mobile wheeled cart.

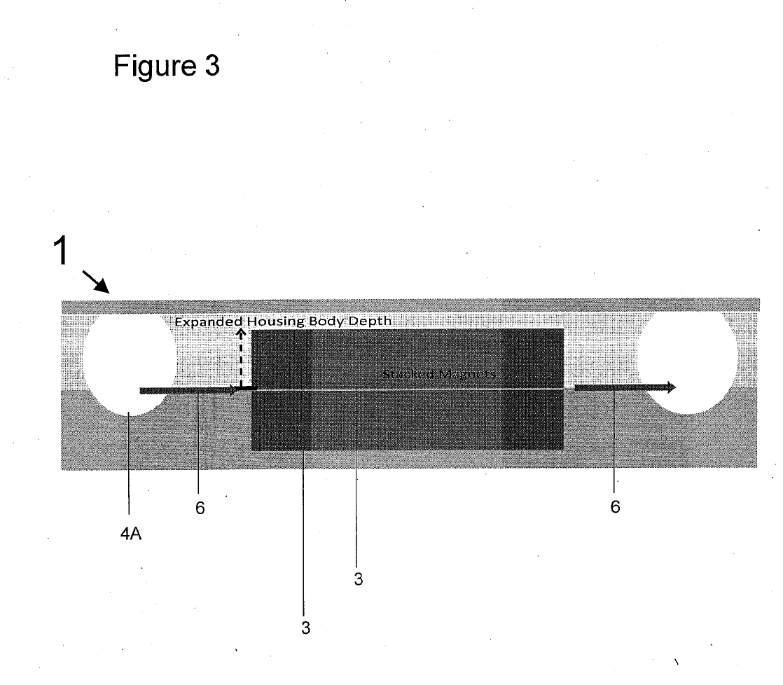

It is important that a variety of applications can be addressed without compromising the often compact space requirements. To increase the fuel flow rate, the depth of the housing body and the diameter of the fuel channel 4 are preferably increased. This is illustrated in FIG. 3 wherein an increase fuel flow volume is achieved by expanding housing body depth, stacking magnets, and enlarging the fuel channel. Magnet size preferably remains the same, as does distance between inlet entry point and outlet exit point.

A further aspect of the present invention is its scalability. According to the present invention the depth of the housing body may be increased to accommodate an expansion to the fuel channel 4 diameter, while the width of the housing body is unchanged. However, with an increase in the housing body depth, additional magnets 3 may be stacked to increase the magnetic force required for the increased fuel flow in larger applications. This design offers a range of application sizes without a significant increase in the overall size of the apparatus 1. This is important due to the restricted space limitations for such requirements for magnetic fuel treatment apparatus.

The U-shaped design of the housing reduces the overall “width” of the present invention, as each series of magnets is situated beside, or parallel to the other, separated only by a section in the centre of the housing. This U-shaped design incorporates the inlet (magnetic) channel, neutral zone channel, and outlet (magnetic) channel, while the overall distance between the inlet entry point and the outlet exit point is approximately one-third of the overall length of the entire fuel channel.

The U-shaped design housing may be increased in depth, thereby increasing the depth of the fuel channel. Increasing the depth of the fuel channel offers the ability to increase the fuel flow rate, thus being able to address a variety of applications. The present invention may use an increase in the housing depth to enable additional rows of magnets to be placed within the single housing. This can increase the fuel magnet exposure and the potential flow rate of the apparatus. This design facilitates the following features:

(1) The distance between the inlet entry point and the outlet exit point remains the same;

(2) The size and shape of the housing cover remains the same; and

(3) Increasing the size of the U-shaped housing does not require a change in the size or shape of the magnets being used. Rather, only the number of magnets being used is changed.

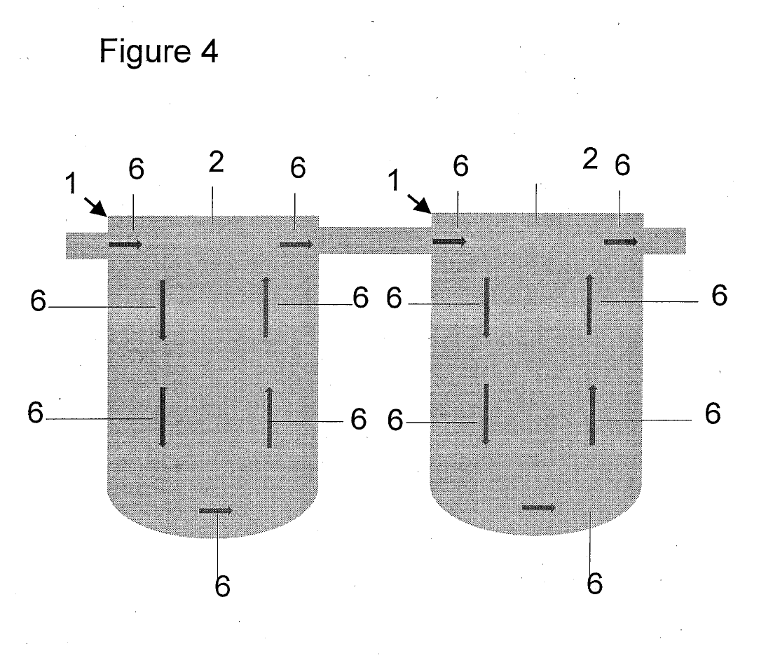

In another embodiment, multiple units could be placed and connected side by side, if space limitations allow. For example, two or more units may be placed side by side, and connected if space limitations allow. This is illustrated in FIG. 4. This may be accomplished by connecting the fuel outlet port of the first unit to the fuel inlet port of the second unit. A third unit could be attached to the second in the same fashion, and so on. This could increase the magnetic exposure and de-polymerization characteristics without decreasing the fuel flow rate.

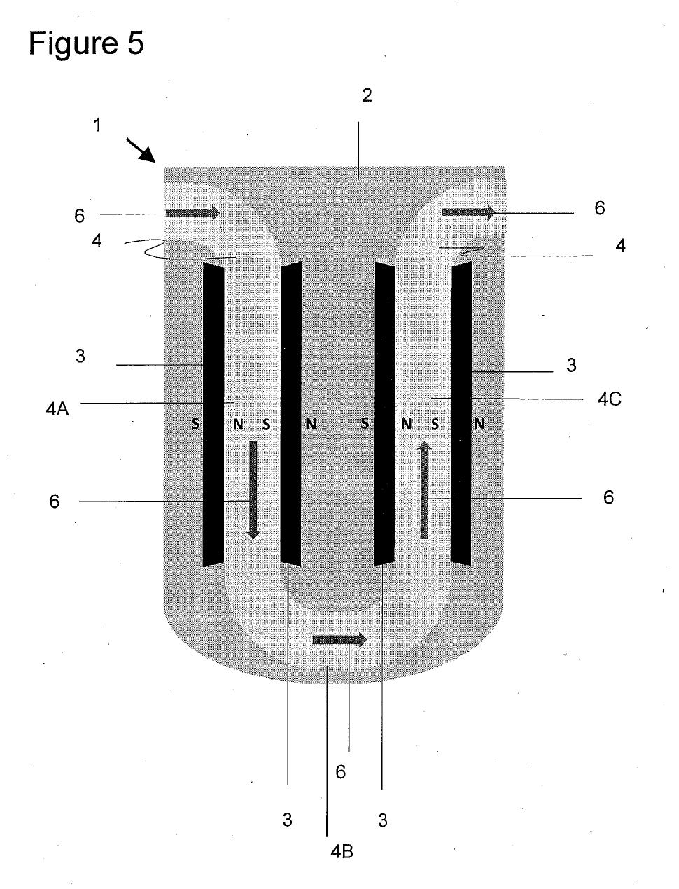

According to another embodiment of the present invention a magnetic fuel treatment apparatus 1 alternatively comprises a series of magnets oriented to create an attracting pairing for a portion of the fuel channel and again a series of magnets oriented to create an attracting pairing for another portion of the fuel channel. (See FIG. 5) Otherwise this embodiment is similar to design and operation described above. It is preferable that a U-shaped portion of the fuel channel separates the two mentioned portions. This “neutral zone” creates a pause in the residence time exposure between the first series of magnets before the fuel is subjected to another magnetic field formed by the orientation of a second series of magnets. Molecular turmoil may be created which may enhance the de-polymerization process. An attracting pairing may be produced by a north pole-south pole combination or a south pole-north pole combination. The present invention may use any combination of poles that face each other on opposing sides of the channels to produce an attracting pairing.

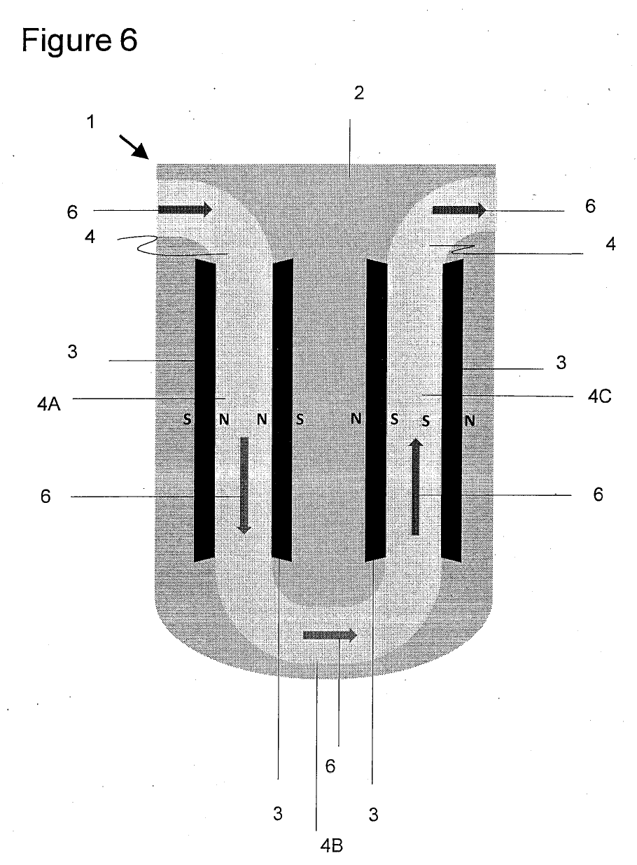

According to a further embodiment of the present invention a magnetic fuel treatment apparatus 1 alternatively comprises a series of magnets oriented to create a repelling pairing for a portion of the fuel channel and again a series of magnets oriented to create a repelling pairing for another portion of the fuel channel. (See FIG. 6) Otherwise this embodiment is similar to the design and operation as immediately described above. It is preferable that a U-shaped portion of the fuel channel separates the two mentioned portions. This “neutral zone” creates a pause in the residence time exposure between the first series of magnets before the fuel is subjected to another magnet field formed by the orientation of a second series of magnets. Molecular turmoil may be created which may enhance the de-polymerization process. A repelling pairing may be produced by a north pole-north pole combination or a south pole-south pole combination. The present invention may use any combination of poles that face each other on opposing sides of the channels which produce a repelling pairing.

While one (or more) embodiment(s) of this invention has (have) been illustrated in the accompanying drawings and described above, it will be evident to those skilled in the art that non-inventive changes and modifications may be made therein without departing from the substance and essence of this invention.

Furthermore, the features and elements of the embodiments described and illustrated may be combined providing other embodiments of the present invention.

The principle and mode of operation of this invention have been explained and illustrated in its preferred embodiment. However, it must be understood that this invention may be practiced otherwise than as specifically explained and illustrated without departing from its spirit or scope.

What is claimed is:

1. Apparatus for the magnetic treatment of fuel, said apparatus comprising:
(a) a body housing said system;
(b) a cover shaped and dimensioned for operational attachment to said body;
(c) at least one fuel channel;
(d) a magnetic force field housed in said body;
(e) said magnetic force field comprising a plurality of magnets so disposed with respect to each other as to provide a force to fuel volume ratio effective in de-polymerizing stored fuel inhibiting fuel deterioration and oxidation and facilitating fuel storage and sludge break up thus enabling said sludge to be introduced into the fuel system; and
(f) at least one channel so structured as to enable flow effectively therethrough.

2. A method for the treatment and storage of fuel including the steps of:
(a) providing a housing for said system;
(b) arranging and positioning a plurality of magnets within said housing;
(c) said magnets being so structured and disposed with respect to each other as to provide a force field;
(d) said force field providing a force to fuel volume ratio effective in de-polymerizing stored fuel, inhibiting fuel deterioration and oxidation and facilitating fuel storage, and
(e) said magnetic force when effectively applied facilitating sludge break up thereafter enabling said sludge to be introduced into the fuel system.

3. A magnetic fuel treatment system and apparatus for stored fuel comprising:
a housing body having at least one doubly open fuel channel;
a cover shaped and dimensioned for attachment to the housing and purposed to cover the fuel channel sufficiently to ensure operability forming at least one doubly open fuel burrow for fuel to flow through;
a first series of magnets disposed on opposing sides of a first portion of the fuel channel oriented in a manner to create a magnet attracting pairing for the said first portion of the fuel channel;
the first series of magnets shaped and positioned to form a portion of the walls of the first portion of the fuel channel; and
a second series of magnets disposed on opposing sides of a second portion of the fuel channel and being oriented in a manner to create a magnet repelling pairing for the second portion of the fuel channel; and
the second series of magnets being so shaped and arranged to form a portion of the walls of the second portion of the fuel channel.

4. The magnetic fuel treatment apparatus according to claim 3 further comprising a third portion of the fuel channel that separates the first and second portion of the fuel channel.

5. The magnetic fuel treatment apparatus according to claim 4, wherein the third portion of the fuel channel is U-shaped.

6. A magnetic fuel treatment apparatus for stored fuel comprising:
a housing body having a doubly open fuel channel;
a cover that is attached to the housing and covers the fuel channel forming a doubly open fuel burrow for fuel to flow through;
a first series of magnets on opposing sides of a first portion of the fuel channel oriented in a manner to create a magnet attracting pairing for the first portion of the fuel channel;
the first series of magnets form a portion of the walls of the first portion of the fuel channel;
a second series of magnets on opposing sides of a second portion of the fuel channel oriented in a manner to create a magnet attracting pairing for the second portion of the fuel channel; and
the second series of magnets form a portion of the walls of the second portion of the fuel channel.

7. The magnetic fuel treatment apparatus according to claim 6, further comprising a third portion of the fuel channel that separates the first and second portion of the fuel channel.

8. The magnetic fuel treatment apparatus according to claim 7, wherein the third portion of the fuel channel is U-shaped.

9. A magnetic fuel treatment apparatus for stored fuel comprising:
a housing body having a doubly open fuel channel;
a cover that is attached to the housing and covers the fuel channel forming a doubly open fuel burrow for fuel to flow through;
a first series of magnets on opposing sides of a first portion of the fuel channel oriented in a manner to create a magnet repelling pairing for the first portion of the fuel channel;
the first series of magnets forming a portion of the walls of the first portion of the fuel channel;
a second series of magnets on opposing sides of a second portion of the fuel channel oriented in a manner to create a magnet repelling pairing for the second portion of the fuel channel; and
the second series of magnets form a portion of the walls of the second portion of the fuel channel.

10. The magnetic fuel treatment apparatus according to claim 9, further comprising a third portion of the fuel channel that separates the first and second portion of the fuel channel.

11. The magnetic fuel treatment apparatus according to claim 10, wherein the third portion of the fuel channel is U-shaped.
